(19) United States
(12) Patent Application Publication
(10) Pub. No.: US 2025/0085378 A1
(43) Pub. Date: Mar. 13, 2025

(54) REFLECTION CONTROL DEVICE, BASE STATION DEVICE, COMMUNICATION METHOD, AND WIRELESS COMMUNICATION SYSTEM

(71) Applicant: FUJITSU LIMITED, Kawasaki-shi (JP)

(72) Inventors: YOSHIHIRO KAWASAKI, Kawasaki (JP); Tetsuya YANO, Yokohama (JP)

(73) Assignee: FUJITSU LIMITED, Kawasaki-shi (JP)

(21) Appl. No.: 18/961,621

(22) Filed: Nov. 27, 2024

Related U.S. Application Data
(63) Continuation of application No. PCT/JP2022/025888, filed on Jun. 29, 2022.

(51) Int. Cl. G01S 5/02

(52) U.S. Cl. CPC G01S 5/0205; G01S 5/0273

(57) ABSTRACT

A base station device in a wireless communication system which includes the base station device, a terminal device, and a reflection control device that receives and reflects a signal that the base station device transmits so as to transmit a reflected wave, and in which the reflection control device changes a reflection angle of the reflected wave in accordance with change in applied voltage, the base station device includes, a determining controller that determines information relating to the applied voltage in the reflected wave and a changing cycle of the applied voltage and a reflection controller that transmits the information to the reflection control device and causes change of the applied voltage to be repeated in the changing cycle in accordance with the information.

### CROSS-REFERENCE TO RELATED APPLICATION

This application is a continuation application of International Application Number PCT/JP2022/025888 filed on Jun. 29, 2022 and designated the U.S., the entire contents of which are incorporated herein by reference.

### FIELD

The present disclosure relates to a reflection control device, a base station device, a control method, and a wireless communication system.

### BACKGROUND

In recent years, a communication system using wireless technology is in use. For instance, in the wireless communication system, wireless communication is realized by transmitting/receiving radio waves between a base station device and a terminal device.

There may be cases in which a base station device is not able to transmit radio waves to a terminal device situated in a communication area of the base station device, in cases in which shielding objects, e.g., buildings or the like are present in the communication area, for instance. In such cases, there may be cases in which the terminal device is not able to perform wireless connection to the base station device, even when the terminal device is within the communication area of the base station device. There is a technology that use a reflection control device that reflects radio waves in such a dead zone, where radio waves within the communication area do not reach, so as to reflect the radio waves. The reflection control device is a device referred to as a RIS (Reconfigurable Intelligent Surface), for instance.

Technology relating to reflecting plates for radio waves is described in the following related art literature.

### CITATION LIST

### Patent Literature

Patent Literature 1: WO 2021/240699

Patent Literature 2: WO 2021/024611

Patent Literature 3: Japanese Patent Application Publication No. 2021-57723

Patent Literature 4: Japanese Patent Application Publication No. 2020-155903

### SUMMARY

A base station device in a wireless communication system which includes the base station device, a terminal device, and a reflection control device that receives and reflects a signal that the base station device transmits so as to transmit a reflected wave, and in which the reflection control device changes a reflection angle of the reflected wave in accordance with change in applied voltage, the base station device includes, a determining controller that determines information relating to the applied voltage in the reflected wave and a changing cycle of the applied voltage and a reflection controller that transmits the information to the reflection control device and causes change of the applied voltage to be repeated in the changing cycle in accordance with the information.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a diagram illustrating a configuration example of a wireless communication system 10.

FIG. 2 is a diagram illustrating a configuration example of the base station device 200.

FIG. 3 is a diagram illustrating a configuration example of the terminal device 100.

FIG. 4 is a diagram illustrating a configuration example of the RIS 300.

FIG. 5 is a diagram illustrating an example of functional blocks of the RIS 300.

FIG. 6 is a diagram illustrating a configuration example of the variable-amplitude signal generating device 380.

FIG. 7 is a diagram illustrating an example of a sequence of reflected wave control processing.

FIG. 8 is a diagram illustrating an example of applied voltage, executed by the RIS 300.

FIG. 9 is a diagram illustrating an example of reflection angle in the applied voltage in FIG. 8.

FIG. 10 is a diagram illustrating an example of the reflection angles in FIG. 9.

### DESCRIPTION OF EMBODIMENTS

### First Embodiment

Reflected waves, which are reflected at a RIS, form a beam that has a breadth to a certain degree, such that the farther from a center axis of the beam, the lower the power density becomes. However, accurately setting reflection angles of the reflected waves (the center axis of the beam) with respect to the terminal device is difficult.

For instance, there may be cases in which the base station device and the RIS are not able to identify, with high precision, the direction and speed of movement of a terminal device that is moving, and tracking with the reflection angles of the reflected waves is difficult. Also, even in cases of a terminal device that does not move, there are cases in which the base station device and the RIS are not able to identify, with high precision, the position of the terminal device, and directing the center axis of the beam of reflected waves toward the direction of the terminal device is difficult.

When the terminal device receives reflected waves at a position away from the center axis of the beam of reflected waves, reception power is low, or reception quality is low, and there may be cases in which wireless communication quality deteriorates.

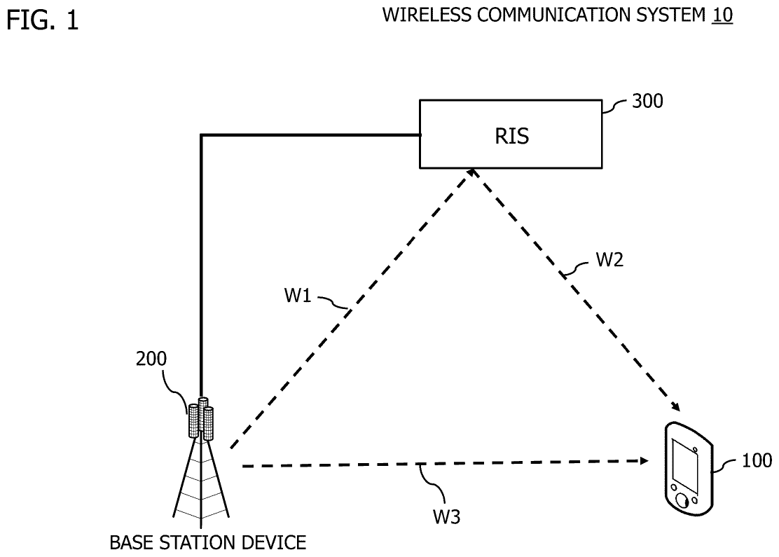

A first embodiment will be described. FIG. 1 is a diagram illustrating a configuration example of a wireless communication system 10. The wireless communication system 10 has a RIS 300, a terminal device 100, and a base station device 200. The wireless communication system 10 is a communication system that performs communication using reflected waves in which radio waves are reflected at the RIS 300.

The base station device 200 wirelessly connects to the terminal device 100 in the communication area, and performs wireless communication. The base station device 200 also has a directional antenna, and is able to control the transmission direction of radio waves by changing multilevel modulation and using the directional antenna.

Also, the base station device 200 performs reflection control of the RIS 300, which will be described later. The base station device 200 controls the reflected waves that are reflected at the RIS 300, and performs control such that the terminal device 100 is able to receive reflected waves appropriately.

The terminal device 100 is a communication device that wirelessly connects to the base station device 200 and performs wireless communication with other terminal devices, and is, for instance, a smartphone or a tablet terminal.

The RIS 300 is a device that reflects radio waves transmitted by the base station device 200 and the terminal device 100, and sends out reflected waves. The RIS 300 reflects radio waves that are received, under control of the base station device 200, for instance. The RIS 300 (reflection control device) has a plurality of RIS elements that are two-dimensionally arrayed on a reflecting face thereof (RIS element group). The RIS elements are made up of, for instance, variable capacitance diodes (varactor diode). Variable capacitance diodes exhibit change in capacitance values upon applied voltage (voltage that is given or placed thereupon) changing, and thus the phase of radio frequency current induced by incident radio waves to the RIS is able to be made to change. That is to say, changing the applied voltage to the RIS elements enables the RIS to change the phase of the reflected waves, and to control the reflection direction (reflection angle) of the reflected waves.

The terminal device 100 performs wireless communication with the base station

device 200 by receiving reflected waves W2 that are radio waves W1 transmitted from the base station device 200 and reflected at the RIS 300, for instance. The terminal device 100 also performs wireless communication with the base station device 200 by receiving radio waves W3 transmitted from the base station device 200, in a case in which wireless communication is able to be directly performed with the base station device 200, for instance.

Although the terminal device 100 is capable of direct communication using the radio waves W3 in FIG. 1, there are cases in which shielding objects or the like are present, for instance, and direct communication is not able to be performed. In this case, the terminal device 100 is able to continue wireless communication by performing communication using the reflected waves W2.

### Configuration Example of Base Station Device 200

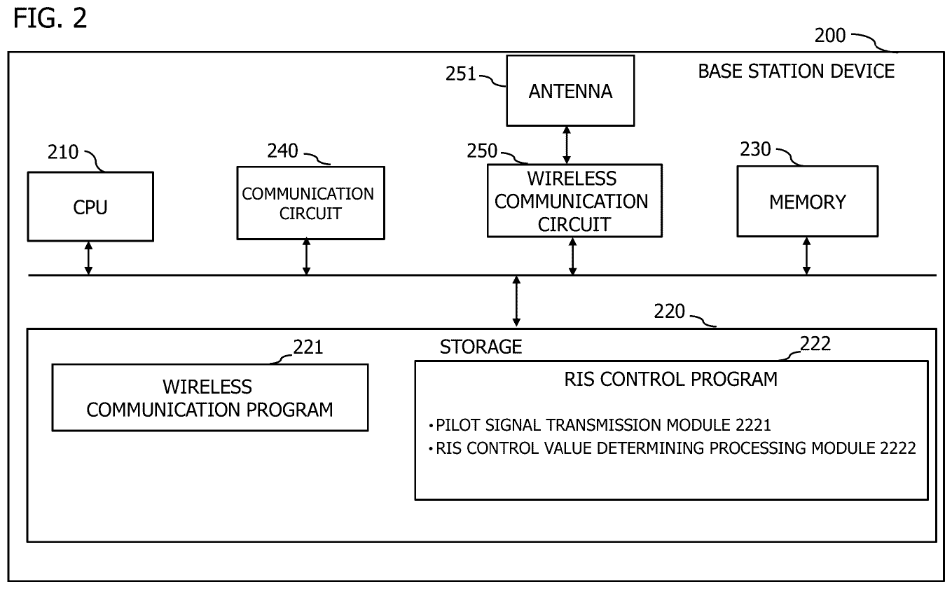

FIG. 2 is a diagram illustrating a configuration example of the base station device 200. The base station device 200 has a CPU (Central Processing Unit) 210, storage 220, memory 230, a communication circuit 240, a wireless communication circuit 250, and an antenna 251.

The storage 220 is an auxiliary storage device, e.g., flash memory, an HDD (Hard

Disk Drive), an SSD (Solid State Drive), or the like, which stores programs and data. The storage 220 stores a wireless communication program 221 and a RIS control program 222.

The memory 230 is a region to which programs stored in the storage 220 are loaded. The memory 230 may also be used as a region for the programs to store data.

The communication circuit 240 is a device that performs communication with other base station devices 200 and the RIS 300. The communication circuit 240 may be a wired communication circuit, e.g., an NI (Network Interface) or the like, or may be a communication circuit that supports wireless connection, for instance.

The wireless communication circuit 250 is a device that performs wireless communication with the terminal device 100, or performs wireless communication with the terminal device 100 via the RIS 300. The wireless communication circuit 250 is wirelessly connected with the terminal device 100, either via the RIS 300 or directly, and realizes wireless communication. The wireless communication circuit 250 has the antenna 251. The antenna 251 includes, for instance, a directional antenna that is capable of controlling the direction of transmission/reception of radio waves.

The CPU 210 is a processor that loads programs stored in the storage 220 to the memory 230, executes the loaded programs, constructs respective units, and realizes respective processing.

The CPU 210 executes the wireless communication program 221, and thereby performs wireless communication processing. The wireless communication processing is processing for wirelessly connecting to the terminal device 100, and realizing the communication that the terminal device 100 executes.

The CPU 210 executes the RIS control program 222, thereby constructing a reflection control unit, a determining unit, and a measuring unit, and performs RIS control processing. The RIS control processing is processing that causes the RIS 300 to execute reflection control. The base station device 200 instructs the RIS 300 regarding reflection angle of reflected waves, changing cycle for changing the reflection angle, greatest reflection angle, lowest reflection angle, and so forth. Note that the base station device 200 may directly give instructions regarding the reflection angle, or may give instructions regarding voltage (applied voltage) corresponding to each reflection angle.

The CPU 210 constructs the measuring unit by executing a pilot signal transmission module 2221 that the RIS control program 222 has, and thereby performs pilot signal transmission processing. The pilot signal transmission processing is processing in which the RIS 300 is caused to transmit a pilot signal to the terminal device 100, the terminal device 100 is caused to measure a wireless state, e.g., reception power and so forth of the pilot signal, and measurement results thereof are received. The pilot signal is transmitted via the RIS 300. The RIS 300 adjusts the reflection angle and so forth of the pilot signal in accordance with instructions from the base station device 200, and performs transmission to the terminal device 100. The measurement results are used to calculate (estimate) the position of the terminal device 100, and to estimate the traveling speed, direction of travel, and so forth, of the terminal device 100, for instance.

The CPU 210 executes a RIS control value determining module 2222 that the RIS control program 222 has, and thereby constructs the determining unit, and performs RIS control value determining processing. The RIS control value determining processing determines information (setting values) relating to reflected waves with which the RIS 300 is to be instructed. The RIS 300 reflects signals received from the base station device 200 in accordance with the RIS control value. The RIS 300 changes the reflection angle from the greatest reflection angle to the lowest reflection angle to the greatest reflection angle (or the lowest reflection angle to the greatest reflection angle to the lowest reflection angle) at a predetermined cycle (changing cycle), which is repeated.

### Configuration Example of Terminal Device 100

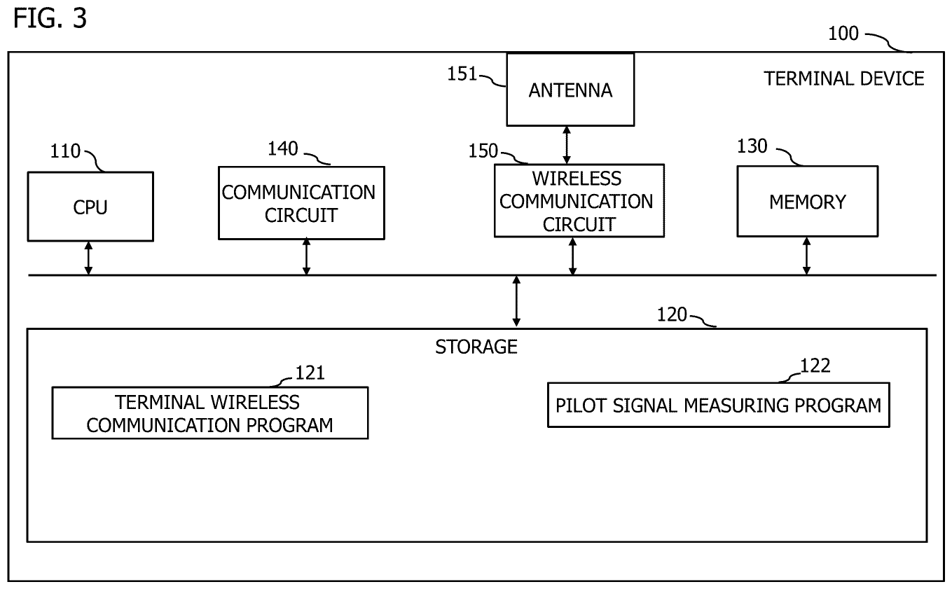

FIG. 3 is a diagram illustrating a configuration example of the terminal device 100. The terminal device 100 has a CPU 110, storage 120, memory 130, a wireless communication circuit 150, and an antenna 151.

The storage 120 is an auxiliary storage device, e.g., flash memory, an HDD, an SSD, or the like, which stores programs and data. The storage 120 stores a terminal wireless communication program 121 and a pilot signal measuring program 122.

The memory 130 is a region to which programs stored in the storage 120 are loaded. The memory 130 may also be used as a region for the programs to store data.

The wireless communication circuit 150 is a device that performs wireless communication with the base station device 200. The wireless communication circuit 150 performs wireless communication with the base station device 200, either via the RIS 300 or directly, and realizes wireless communication. The wireless communication circuit 150 has the antenna 151. The antenna 151 includes, for instance, a directional antenna that is capable of controlling the direction of transmission/reception of radio waves.

The CPU 110 is a processor that loads programs stored in the storage 120 to the

memory 130, executes the loaded programs, constructs respective units, and realizes respective processing.

The CPU 110 executes the terminal wireless communication program 121, and thereby performs terminal wireless communication processing. The terminal wireless communication processing is processing for wirelessly connecting to the base station device 200, and realizing wireless communication with other terminal devices 100 and the base station device 200.

The CPU 110 executes the pilot signal measuring program 122, and thereby performs pilot signal measuring processing. The pilot signal measuring processing is processing of measuring pilot signals reflected via the RIS 300, and transmitting measurement results thereof to the base station device 200.

### Configuration Example of RIS 300

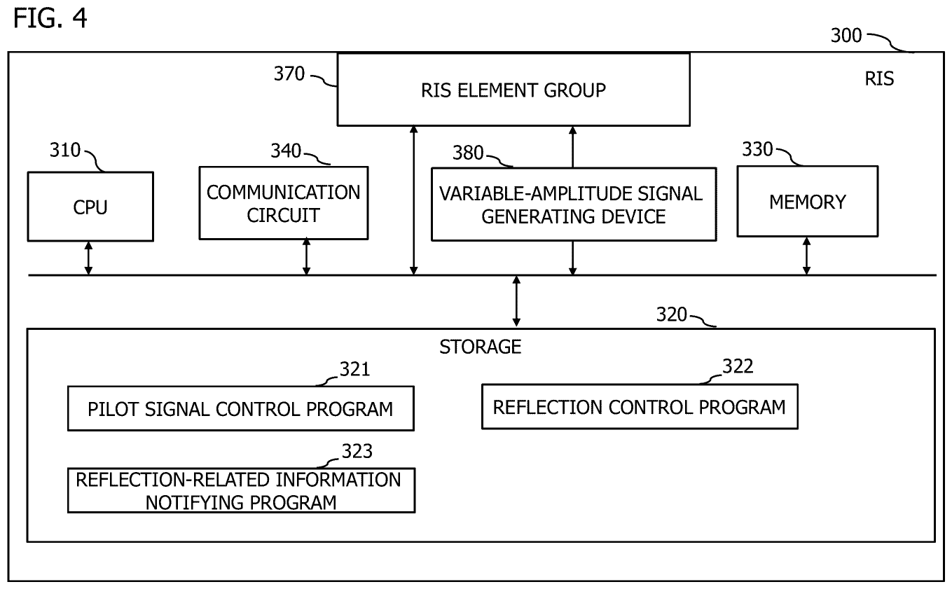

FIG. 4 is a diagram illustrating a configuration example of the RIS 300. The RIS 300 has a CPU (Central Processing Unit) 310, storage 320, memory 330, a communication circuit 340, an RIS element group 370, and a variable-amplitude signal generating device 380.

The storage 320 is an auxiliary storage device, e.g., flash memory, an HDD, an SSD, or the like, which stores programs and data. The storage 320 stores a pilot signal control program 321, a reflection control program 322, and a reflection-related information notifying program 323.

The memory 330 is a region to which programs stored in the storage 320 are loaded. The memory 330 may also be used as a region for the programs to store data.

The communication circuit 340 is a device that performs communication with the base station device 200. The communication circuit 340 may be a wired communication circuit, e.g., an NI (Network Interface) or the like, for instance, or may be a communication circuit that supports wireless connection.

The RIS element group 370 is a set of the plurality of RIS elements that receive radio waves transmitted by the base station device 200 and the terminal device 100, and sends the radio waves out at a desired angle. The RIS element group 370 is capable of receiving radio waves and transmitting (reflecting) radio waves in increments of RIS elements. Also, the reflection angle of reflected waves is controlled at the RIS element group 370 by input overvoltage being changed.

The variable-amplitude signal generating device 380 is a device that generates variable-amplitude bias signals (or applied voltage) to be supplied to the RIS element group 370. The variable-amplitude signal generating device 380 takes direct current voltage as input, and outputs voltage that fluctuates cyclically in accordance with amplitude (variable-amplitude bias signals), for instance.

The CPU 310 is a processor that loads programs stored in the storage 320 to the memory 330, executes the loaded programs, constructs respective units, and realizes respective processing.

The CPU 310 executes the pilot signal control program 321, and thereby constructs a communication unit and performs pilot signal control processing. The pilot signal control processing is processing of reflecting pilot signals received from the base station device 200 in accordance with instructions from the base station device 200, and transmitting the pilot signals to the terminal device 100.

The CPU 310 executes the reflection control program 322, and thereby constructs a control unit, the communication unit, and a reflecting unit, and performs reflection control processing. The reflection control processing is processing for controlling reflection of the radio waves that are received. The RIS 300 performs reflection control in the reflection control processing, under instructions (RIS control values) from the base station device 200. The RIS 300 changes the voltage (applied voltage) for the RIS element group 370, and changes the reflection angle of the reflected waves within the changing cycle. The RIS 300 changes the reflection angle from the greatest reflection angle to the lowest reflection angle to the greatest reflection angle (or the lowest reflection angle to the greatest reflection angle to the lowest reflection angle) within the changing cycle, which is repeated.

The CPU 310 constructs the communication unit by executing the reflection-related information notifying program 323, and thereby performs reflection-related information notifying processing. The reflection-related information notifying processing is processing of transmitting reflection-related information to the base station device 200. The reflection-related information is information relating to reflection, and includes a correlative relation between applied voltage for the RIS element group 370 (or RIS 300) and the reflection angle, for instance. The reflection-related information does not have to be notified in cases in which the base station device 200 is recognized in advance. Also, the reflection-related information does not have to be notified in cases in which the base station device 200 controls the RIS 300 by reflection angle or changing cycle, rather than by the value of the applied voltage (cases in which the base station device 200 does not have to recognize the applied voltage).

### Functional Blocks of RIS 300

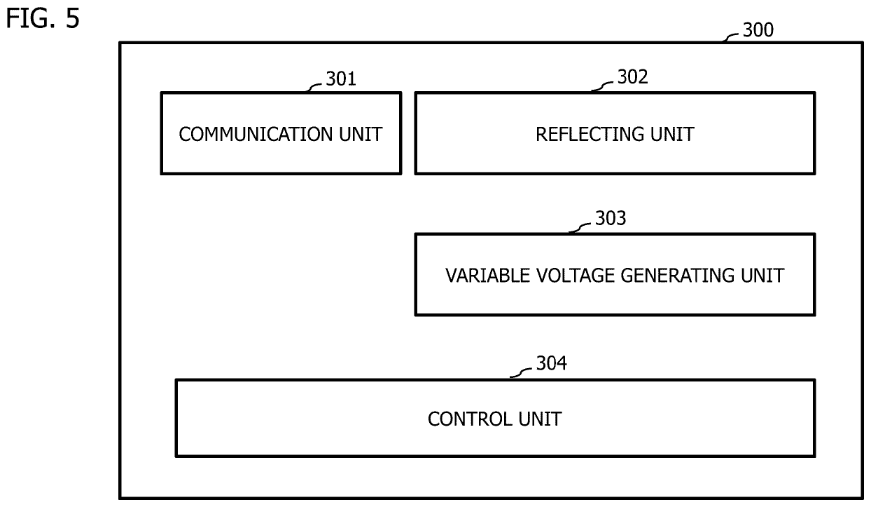

FIG. 5 is a diagram illustrating an example of functional blocks of the RIS 300. The RIS 300 has a communication unit 301, a reflecting unit 302, a variable voltage generating unit 303, and a control unit 304.

The communication unit 301 performs communication with the base station device

200. The communication unit 301 is constructed by the CPU 310 executing a program, and realizes communication by controlling the communication circuit 340.

The reflecting unit 302 reflects radio waves (signals) received from the base station device 200 or the terminal device 100. The reflecting unit 302 changes the reflection angle in accordance with applied voltage received from the variable voltage generating unit 303 which will be described later, and sends out the reflected waves. The reflecting unit 302 is, for instance, the RIS element group 370. Also, part of the reflecting unit 302 may be constructed by the CPU 310 executing a program.

The variable voltage generating unit 303 supplies variable voltage to the reflecting unit 302. The variable voltage is voltage that fluctuates in accordance with a cycle and an amplitude that are constant. The variable voltage generating unit 303 is, for instance, the variable-amplitude signal generating device 380. Also, part of the variable voltage generating unit 303 may be constructed by the CPU 310 executing a program.

The control unit 304 controls reflected waves and communication. The control unit 304 generates variable voltage in accordance with information (instruction) relating to reflected waves received from the base station device 200, and changes the reflection angle at a cycle that is constant. The control unit 304 is constructed by the CPU 310 executing a program, for instance.

### Variable-Amplitude Signal Generating Device

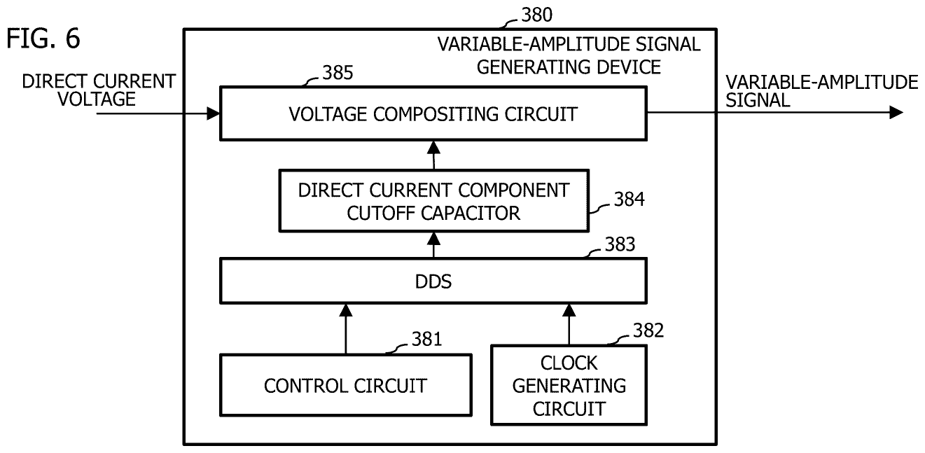

FIG. 6 is a diagram illustrating a configuration example of the variable-amplitude signal generating device 380. The variable-amplitude signal generating device 380 is a device that takes direct current electric current as input, and outputs variable-amplitude signals. The variable-amplitude signal generating device 380 has a control circuit 381, a clock generating circuit 382, a DDS (Direct Digital Synthesizer: direct digital synthesizer) 383, a direct current component cutoff capacitor 384, and a voltage compositing circuit 385.

The control circuit 381 is a circuit that performs control of outputting variable-

amplitude signals that are desired. The variable-amplitude signals that are desired are notified (instructed) from the control unit 304, for instance.

The clock generating circuit 382 is a circuit that generates a clock. Giving the clock to the DDS 383 makes the DDS 383 recognize the cycle.

The DDS 383 is a device that accumulates a frequency setting value, synchronously with the clock, and outputs signals of a speed proportionate to the frequency setting value. The DDS 383 uses the clock that is input to generate and output signals of which the voltage fluctuates at a cycle that is constant.

The direct current component cutoff capacitor 384 is a capacitor for cutting off direct current component from signals that are input. The direct current component cutoff capacitor 384 cuts off the direct current component from the signals that are input, and outputs the signals to the voltage compositing circuit 385.

The voltage compositing circuit 385 is a device that composites a plurality of voltages. The voltage compositing circuit 385 composites the signals (voltage) of a constant cycle that are input from the direct current component cutoff capacitor 384, and the direct current electric current that is input, and generates and outputs variable-amplitude signals.

### Reflected Wave Control Processing

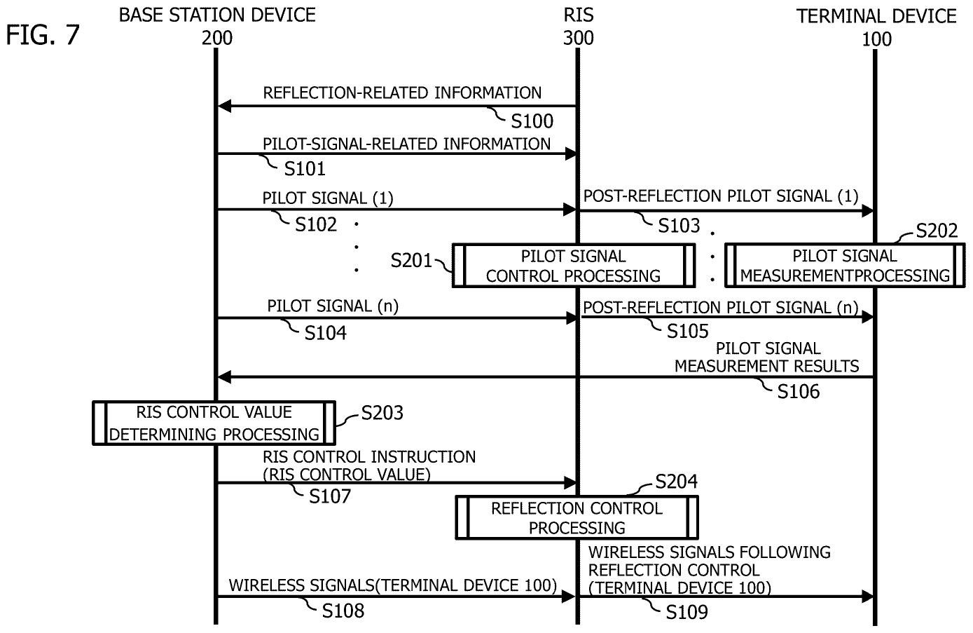

FIG. 7 is a diagram illustrating an example of a sequence of reflected wave control processing. The RIS 300 transmits reflection-related information to the base station device 200 (S100).

The reflection-related information is information relating to reflected waves, and includes information indicating a relation between applied voltage and reflection angle. The reflection angle is determined in accordance with the applied voltage, but differs depending on the types of the RIS elements that the RIS 300 is equipped with, for instance. Accordingly, the RIS 300 notifies the base station device 200 regarding the relation between applied voltage and reflection angle of the RIS elements that it is equipped with. Note that in a case in which the base station device 200 recognizes the relation between the applied voltage and the reflection angle of the RIS elements in advance, the RIS 300 does not have to perform notification of reflection-related information.

The base station device 200 transmits pilot-signal-related information to the RIS 300 (S101). The pilot-signal-related information includes what sort of signals that the pilot signals which will be transmitted thereafter are (identifier of signals, transmission strength, transmission timing, transmission count, and so forth). Also, pilot-signal-related information includes information relating to applied voltage at the time of reflecting the pilot signals. Note that this may be the reflection angle instead of applied voltage.

Upon receiving the pilot-signal-related information (S101), the RIS 300 performs storing thereof in internal memory, for instance. The RIS 300 then executes pilot signal control processing S201, which will be described later, following (on the basis of) the pilot-signal-related information.

The base station device 200 transmits the pilot signals to the RIS 300 (S102). Note that an n (where n is an integer of 1 or greater) count of pilot signals are transmitted. The pilot signal that is transmitted the n-th in order will be written as pilot signal (n), and reflected waves will be expressed in the same way.

Upon receiving a pilot signal (1) (S102), the RIS 300 starts the pilot signal control processing S201. The pilot signal control processing S201 is performed until the transmission of the series of pilot signals is completed. The pilot signal control processing S201 is processing of receiving pilot signals, changing the applied voltage of the RIS element group 370, reflecting the pilot signals, and sending out post-reflection pilot signals, in accordance with the pilot-signal-related information that is stored.

In the pilot signal control processing S201, the RIS 300 reflects the pilot signal (1) that is received, as a post-reflection pilot signal (1), in accordance with the pilot-signal-related information. The RIS 300 performs the same processing until the pilot signal (n) is received (S104), and a post-reflection pilot signal (n) is reflected (S105).

Upon receiving the post-reflection pilot signal (1) (S103), the terminal device 100 performs pilot signal measurement processing S202. The pilot signal measurement processing S202 is processing of transmitting measurement results of having measured reception strength, phase, reception quality and so forth, of the pilot signal that is received, to the base station device 200.

The terminal device 100 measures each of the post-reflection pilot signals in the pilot signal measurement processing S202, and transmits the pilot signal measurement results to the base station device 200 (S106). Note that the pilot signal measurement results may be transmitted each time one post-reflection pilot signal is received, for instance.

Upon receiving the pilot signal measurement results (S106), the base station device 200 executes RIS control value determining processing S203. The RIS control value determining processing S203 is processing for determining settings relating to reflected waves (RIS control value) with which the RIS 300 is to be instructed, for instance. Details of the RIS control value will be described later.

The base station device 200 includes the RIS control value determined in the RIS control value determining processing S203 in a RIS control instruction, and performs transmission thereof to the RIS 300 (S107).

Upon receiving the RIS control instruction (S107), the RIS 300 stores the RIS control value and executes reflection control processing S204 that follows.

Upon receiving wireless signals from the base station device 200 to the terminal device 100 (S108), for instance, the RIS 300 transmits reflected waves in accordance with the RIS control value in the reflection control processing S204 (S109).

### RIS Control Value

The RIS control value will be described. The base station device 200 controls applied voltage to the RIS element group 370 of the RIS 300, thereby causing the reflected waves to reciprocate at a predetermined cycle, in a predetermined direction and with a predetermined width.

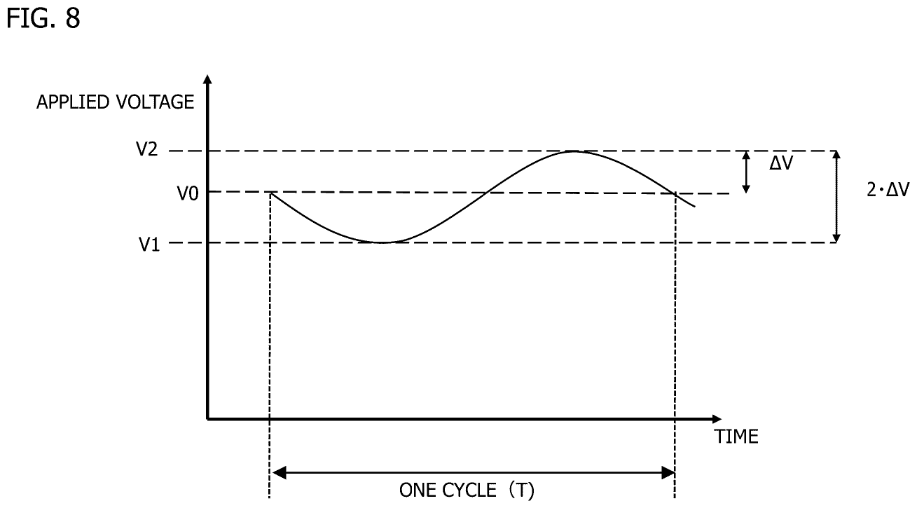

FIG. 8 is a diagram illustrating an example of applied voltage, executed by the RIS

300. The RIS 300 cyclically changes the applied voltage as illustrated in FIG. 8, in accordance with the instruction (RIS control value) of the base station device 200, for instance. Note that the graph in FIG. 8 has a form resembling that of a sine wave, but may be configured as a straight line (proportional graph), for instance.

The RIS causes fluctuation from voltage V2 that is ΔV above a voltage V0 that is the center to voltage VI that is ΔV below the voltage V0, within one cycle T. The width of the applied voltage is 2×ΔV. The RIS 300 repeats this cycle of applied voltage.

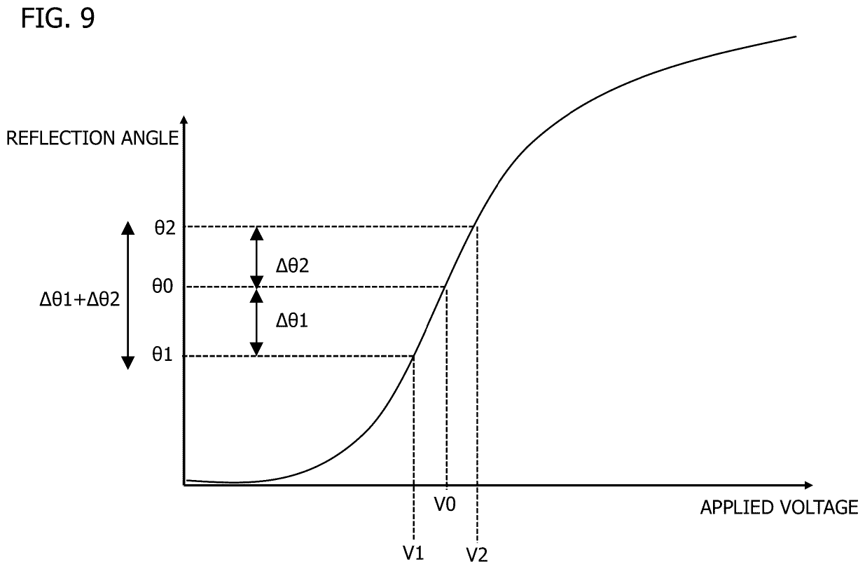

FIG. 9 is a diagram illustrating an example of reflection angle in the applied voltage in FIG. 8. The graph in FIG. 9 illustrates an example of the relation between applied voltage and reflection angle of the reflected waves (angle of center axis). For instance, the greater the applied voltage is, the greater the reflection angle becomes, and the lower the applied voltage is, the lower the reflection angle becomes.

When the applied voltage is V0, the reflection angle is θ0. θ0 is, for instance, a middle angle between the greatest reflection angle and the lowest reflection angle in the cycle (a rough average value of the greatest reflection angle and the lowest reflection angle). Also, θ0 is the center of the amplitude, and hereinafter may be referred to as center angle.

When the applied voltage is V1, the reflection angle is θ1. Also, when the applied voltage is V2, the reflection angle is θ2. Note that the difference between θ1 and θ0 is Δθ1, and the difference between θ2 and θ0 is Δθ2. The difference between θ1 and 02 is Δθ1 +Δθ2.That is to say, the difference between the greatest reflection angle and the lowest reflection angle of the reflection angle is Δθ1+Δθ2.

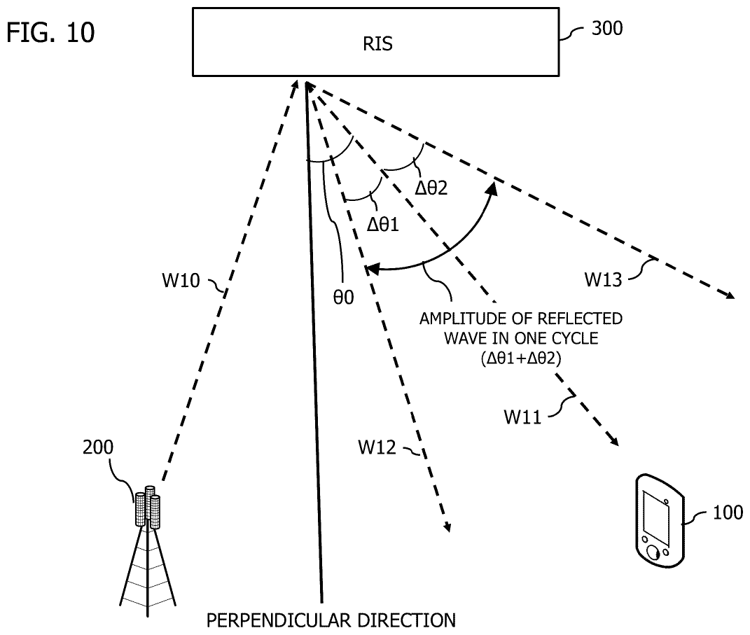

FIG. 10 is a diagram illustrating an example of the reflection angles in FIG. 9. Note that the reflection angle here is the angle of the reflected waves as to a direction perpendicular to the reflecting face of the RIS 300. Also, while the reflection angle is depicted in a planar manner in FIG. 10, in reality, control of the angle may be performed three-dimensionally. Also, the reflection angles of reflected waves W11 to 13 in FIG. 10 indicate the angles of the center axis of the reflected waves.

The base station device 200 transmits a signal W10 to the terminal device 100. The RIS 300 sets the applied voltage to V0 such that the reflection angle of the center of the reflected wave is 00, in accordance with the RIS control value, and transmits the reflected wave W11. The RIS 300 then gradually reduces the applied voltage to V1, and transmits the reflected wave W12 of which the reflection angle is lower than θ0 by Δθ1. Further, the RIS 300 gradually raises the applied voltage to V2, and transmits the reflected wave W13 of which the reflection angle is greater than θ0 by Δθ2.

Thereafter, the RIS 300 changes the settings of the applied voltage from V1 to V2 within one cycle, and changes the center angle of the reflected waves within one cycle. Note that the RIS 300 performs the raising and reducing of the applied voltage in a gradual manner, for instance, thereby changing the reflection angle gradually. For instance, the RIS 300 changes the applied voltage by the lowest increment in which switching of the applied voltage is able to be performed.

Accordingly, the reflected waves reciprocate between the amplitude 401 +402 within one cycle. Even in a case in which the terminal device 100 is not situated at the direction of an initial center angle θ0, the terminal device 100 is able to receive reflected waves by being situated within this amplitude.

As described above, the base station device 200 causes the RIS 300 to repeat changing of the reflection angle at a predetermined cycle. Accordingly, the RIS control value includes, for instance, the applied voltage at the center angle, the greatest applied voltage, the lowest applied voltage, the cycle, and so forth. Also, the RIS control value may be the center angle, the lowest angle, the greatest angle, the cycle, and so forth. In this case, the base station device 200 sets the applied voltage in accordance with each angle, so as to be the center angle, the lowest angle, and the greatest angle. Cycle

The cycle is set on the basis of a symbol length of a signal (e.g., OFDM signal) transmitted and received between the base station device 200 and the terminal device 100, for instance. In a case in which the symbol length is L, the cycle is L/N (N is 1, 2, 4, 8 . . . , for instance). Also, the cycle may be set from a doppler frequency calculated from a phase change amount at the base station device 200 of pilot signals that the terminal device 100 transmits at a certain interval.

### Amplitude

The amplitude is set in accordance with movement prediction regarding the terminal device 100, for instance. The faster the movement speed of the terminal device 100 is, the wider the amplitude is set. Note that the movement speed is predicted to be faster the higher the doppler frequency is, for instance.

Also, the amplitude is set in accordance with the certainty of the position of the terminal device 100 (prediction precision of position, accuracy) predicted from the pilot signal measurement results of the terminal device 100, for instance. The lower the precision of the predicted position of the terminal device 100 is, the wider the amplitude is set.

The amplitude is set in accordance with the amount of time elapsed from the base station device receiving the pilot signal measurement results from the terminal device the last time, for instance. The longer the amount of time elapsed from reception thereof the last time is, the wider the amplitude is set.

### How to Change Applied Voltage

How to change the applied voltage will be described. The way in which the applied voltage is changed is coordinated with the way in which the angle of reflected waves is changed.

The reflection control device 300 gradually changes the applied voltage, for instance. The reflection control device 300 changes the applied voltage in predetermined value increments. The predetermined value may be a constant value, or may be a different value.

The reflection control device 300 changes the applied voltage as illustrated in the graph in FIG. 8, for instance. According to the graph in FIG. 8, at a certain period in the cycle, the voltage amount (predetermined value) that is changed is not constant. The graph in FIG. 8 is a graph that is close to a sine wave, for instance. In a case of a sine wave, the voltage amount that is changed in a predetermined period is great near the peaks of the graph (near the greatest value V2 and the lowest value V1), and the voltage amount that is changed in a predetermined period is low near bases of the graph (near the center value VO).

The reflection control device 300 also may change in increments of a predetermined voltage amount (predetermined value), for instance. In this case, the voltage amount that is changed in a certain period in the cycle will be constant.

That is to say, the applied voltage preferably is not changed rapidly. The reflection control device 300 changes the applied voltage a little at a time, rather than changing rapidly, in order to continuously change the reflection angle.

Note that in a case in which the reflection control device 300 has a mechanism that enables the applied voltage to be changed in analog (continuously, rather than rapid change), or change that is close to that of analog, for instance, this mechanism may be used to change the applied voltage.

### Other Embodiments

In the first embodiment, the base station device 200 controls the angle of reflected waves by the RIS 300 by instructing the applied voltage. However, the base station device 200 may instruct the RIS 300 of the angle and cycle of reflected waves, for instance, without considering the applied voltage. In this case, the RIS 300 changes the applied voltage so as to achieve the angle that is instructed.

The disclosure is capable of suppressing deterioration of wireless communication quality at a terminal device, in a communication system that uses reflected waves.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is;:

1. A base station device in a wireless communication system which includes the base station device, a terminal device, and a reflection control device that receives and reflects a signal that the base station device transmits so as to transmit a reflected wave, and in which the reflection control device changes a reflection angle of the reflected wave in accordance with change in applied voltage, the base station device comprising:
a determining controller that determines information relating to the applied voltage in the reflected wave and a changing cycle of the applied voltage; and
a reflection controller that transmits the information to the reflection control device and causes change of the applied voltage to be repeated in the changing cycle in accordance with the information.

2. The base station device according to claim 1, further comprising:
a measuring controller that transmits a pilot signal to the terminal device via the reflection control device and receives a measurement result by the terminal device that has received and measured the pilot signal.

3. The base station device according to claim 2, wherein
the determining controller determines a first applied voltage and a second applied voltage, as the applied voltage of the information, and
the reflection controller causes the reflection control device to repeat changing from the first applied voltage to the second applied voltage, and from the second applied voltage to the first applied voltage, at the changing cycle.

4. The base station device according to claim 3, wherein
the reflection controller executes the change in a stepwise manner from the first applied voltage to the second applied voltage, and the change from the second applied voltage to the first applied voltage, by changing voltage within a predetermined value.

5. The base station device according to claim 3, wherein
the measuring controller predicts from the measurement result a degree of movement of the terminal device, and
the determining controller determines the first applied voltage and the second applied voltage in accordance with the degree of movement of the terminal device that the measuring controller has predicted.

6. The base station device according to claim 3, wherein
the measuring controller predicts from the measurement result a position of the terminal device, and
the determining controller determines the first applied voltage and the second applied voltage in accordance with accuracy of the position of the terminal device that the measuring controller has predicted.

7. The base station device according to claim 3, wherein
the measuring controller predicts from the measurement result a position of the terminal device, and
the determining controller determines the first applied voltage and the second applied voltage such that a direction of the position of the terminal device that the measuring controller has predicted is at the center.

8. The base station device according to claim 4, wherein
the determining controller determines the first applied voltage and the second applied voltage in accordance with an amount of time that elapsed from a time of receiving the measurement result.

9. The base station device according to claim 5, wherein
the determining controller determines the first applied voltage and the second applied voltage in accordance with an amount of time that elapsed from a time of receiving the measurement result.

10. The base station device according to claim 6, wherein
the determining controller determines the first applied voltage and the second applied voltage in accordance with an amount of time that elapsed from a time of receiving the measurement result.

11. The base station device according to claim 7, wherein
the determining controller determines the first applied voltage and the second applied voltage in accordance with an amount of time that elapsed from a time of receiving the measurement result.

12. The base station device according to claim 1, wherein
the determining controller determines the changing cycle in according with a symbol length of the signal that the base station device transmits.

13. A reflection control device receiving and reflecting a signal that a base station device transmits so as to transmit a reflected wave, the reflection control device comprising:
a reflector that changes a reflection angle of the reflected wave in accordance with change in applied voltage;
a communicator that receives information relating to the applied voltage and a changing cycle of the applied voltage from the base station device, and a controller that repeats changing of the applied voltage input to the reflector in the changing cycle, in accordance with the information.

14. A wireless communication system which includes a base station device, a terminal device, and a reflection control device that receives and reflects a signal that the base station device transmits so as to transmit a reflected wave, and in which the reflection control device changes a reflection angle of the reflected wave in accordance with change in applied voltage, wherein
the base station device
determines information relating to the applied voltage in the reflected wave and a changing cycle of the applied voltage, and
transmits the information to the reflection control device, and the reflection control device
receives the information, and
repeats changing of the applied voltage in the changing cycle in accordance with the information.
